(19) United States
(12) Patent Application Publication
(10) Pub. No.: US 2008/0183539 A1
(43) Pub. Date: Jul. 31, 2008

(54) Consistency Checking in Computer-Implemented Calendar Systems

(76) Inventors: Boaz Mizrachi, Haifa (IL); Elad Yom-Tov, Mitzpeh Hoshaya (IL)

Correspondence Address: Stephen C. Kaufman;IBM CORPORATION, Intellectual Property Law Dept., P.O. Box 218, Yorktown Heights, NY, 10598, US

(21) Appl. No.: 11/669,199

(22) Filed: Jan. 31, 2007

(51) Int. Cl. G06Q 10/00

(52) U.S. Cl. 705/8

(57) ABSTRACT

A computer-implemented calendar verification system including a computer configured to operate a calendar application, and a consistency checker operable by the computer, where the calendar application is operative to record information regarding a scheduled event, and where the consistency checker is operative to determine the consistency of a sender time-to-event, received in a verification message for the event, with a recipient time-to-event calculated by the consistency checker using the scheduled event information.

### FIELD OF THE INVENTION

The present invention relates to computer-implemented calendar systems in general, and in particular to checking the consistency of the same scheduled events recorded by calendar applications for different parties.

### BACKGROUND OF THE INVENTION

The computer-implemented calendar has become an essential tool for conducting business. One important feature provided by calendar applications allows one party to schedule an event within his/her calendar application and send an invitation from his/her calendar application to the event to other parties, whereupon each invitee's calendar application may be used to accept the invitation and record the date and time of the event. For example, in FIG. 1A a calendar application that is executed by a computer 100 is used to schedule a meeting for July 10th between 6 PM-8 PM EST and send invitations to the meeting via a network 102, such as a company network and/or the Internet, to parties at computers 104, 106, and 108. After the invitees accept the invitations, the calendar applications executed by their computers record the date and time of the event, such as in data stores 104A, 106A, and 108A respectively, as shown in FIG. 1B. Since computers 104, 106, and 108 may or may not be located in the same time zone as computer 100, the date and time of the event as recorded in data stores 104A, 106A, and 108A may be adjusted to reflect the time of the meeting in each computer's time zone. Thus, the meeting time of 6PM-8PM EST in computer 100's time zone is recorded as such by computer 104, being in the same time zone as computer 100, whereas the meeting time is recorded by computer 106 as occurring at 5 PM-7 PM in computer 106's time zone, and by computer 108 as occurring at 11 AM-1 PM in computer 108's time zone, due to computers 106 and 108 being in different time zones than computer 100.

Unfortunately, if a computer's clock is set incorrectly, or if a time zone adjustment is made incorrectly or not at all, or if the computer's clock is changed to/from daylight savings time, the same event that is scheduled by different calendar applications on different computers may be incorrectly scheduled to take place at times other than the event's originally scheduled time, event when adjusted for time zone differences.

### SUMMARY OF EMBODIMENTS OF THE INVENTION

The present invention in embodiments thereof discloses architecture and methods for checking the consistency of the same scheduled events recorded at calendar applications for different parties.

In one aspect of the present invention a computer-implemented calendar verification system is provided including a computer configured to operate a calendar application, and a consistency checker operable by the computer, where the calendar application is operative to record information regarding a scheduled event, and where the consistency checker is operative to determine the consistency of a sender time-to-event, received in a verification message for the event, with a recipient time-to-event calculated by the consistency checker using the scheduled event information.

In another aspect of the present invention a computer-implemented calendar verification method is provided including receiving a verification message for a scheduled event, accessing information regarding the scheduled event, and determining the consistency of a sender time-to-event received in the verification message with a recipient time-to-event calculated by the recipient of the verification message using the scheduled event information.

In another aspect of the present invention a computer-implemented program is provided embodied on a computer-readable medium, the computer program including a first code segment operative to receive a verification message for a scheduled event, a second code segment operative to access information regarding the scheduled event, and a third code segment operative to determine the consistency of a sender time-to-event received in the verification message with a recipient time-to-event calculated by the recipient of the verification message using the scheduled event information.

### BRIEF DESCRIPTION OF THE DRAWINGS

Embodiments of the present invention will be understood and appreciated more fully from the following detailed description taken in conjunction with the appended drawings in which:

FIGS. 1A and 1B, taken together, are simplified conceptual illustrations of the operation of a computer-implemented calendar system;

FIG. 2 is a simplified conceptual illustration of a computer-implemented calendar verification system, constructed and operative in accordance with an embodiment of the present invention;

FIG. 3 is a simplified flowchart illustration of an exemplary method of operation of the calendar verification system of FIG. 2, operative in accordance with an embodiment of the present invention; and

FIG. 4 is a simplified flowchart illustration of an alternate exemplary method of operation of the calendar verification system of FIG. 2, operative in accordance with an embodiment of the present invention.

### DETAILED DESCRIPTION OF EMBODIMENTS OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

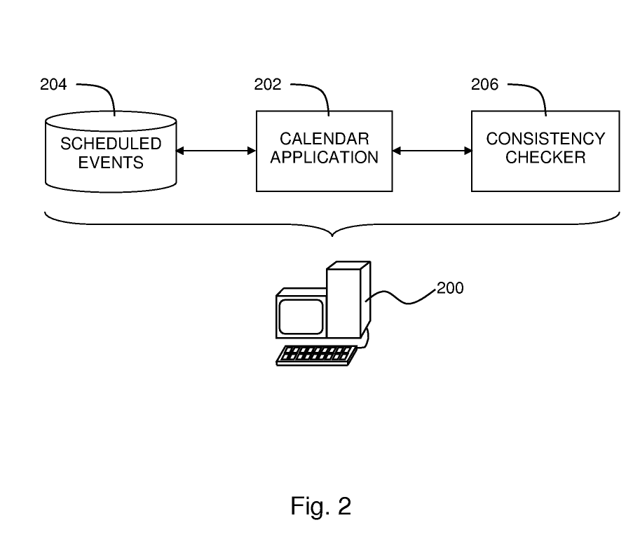

Reference is now made to FIG. 2, which is a simplified conceptual illustration of a computer-implemented calendar verification system, constructed and operative in accordance with an embodiment of the present invention. In the system of FIG. 2, a computer 200 is configured to operate a calendar application 202, such as a network-based calendar application to which computer 200 has access or a calendar application that is installed on computer 200. Calendar application 202 preferably records information regarding scheduled events, such as the date, time, description, and venue of the event, in a database 204. Computer 200 is also configured to operate a consistency checker 206, which may likewise be network-based and accessible to computer 202 or installed on computer 200.

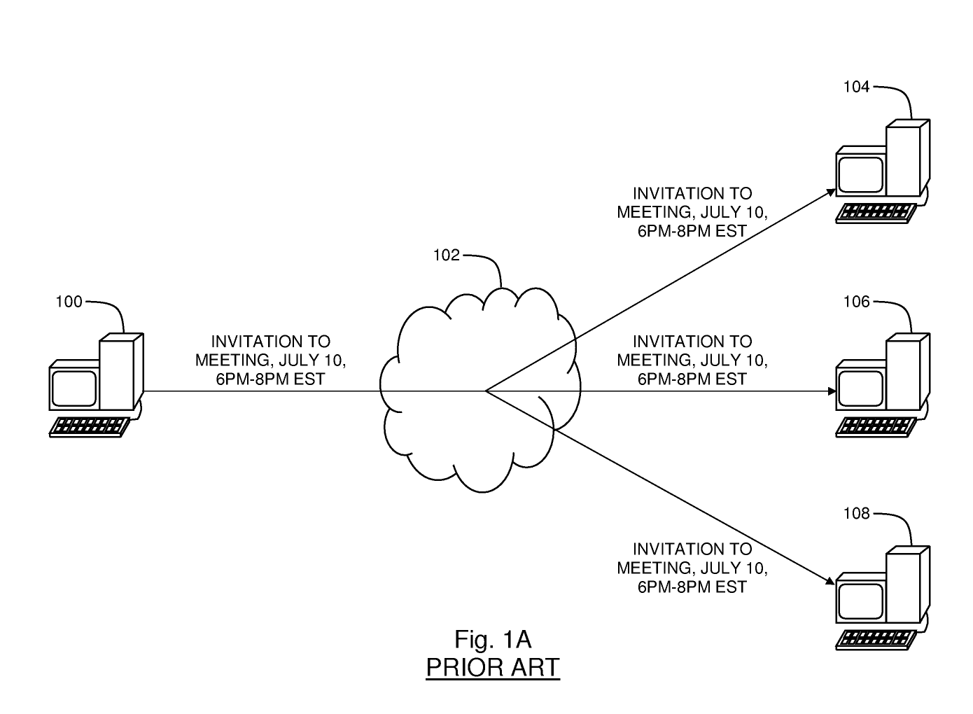

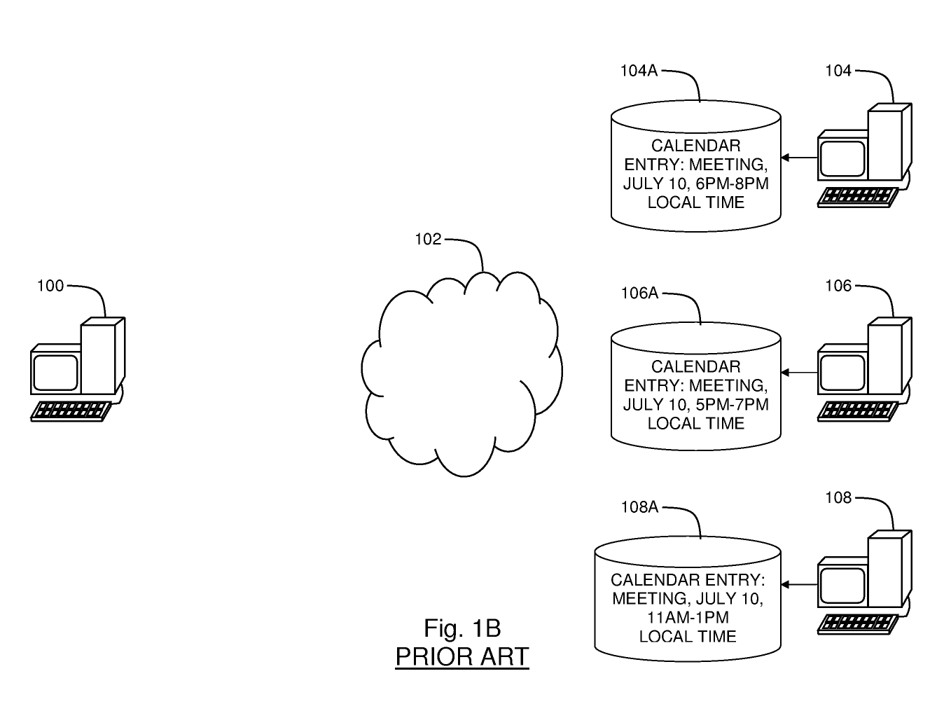

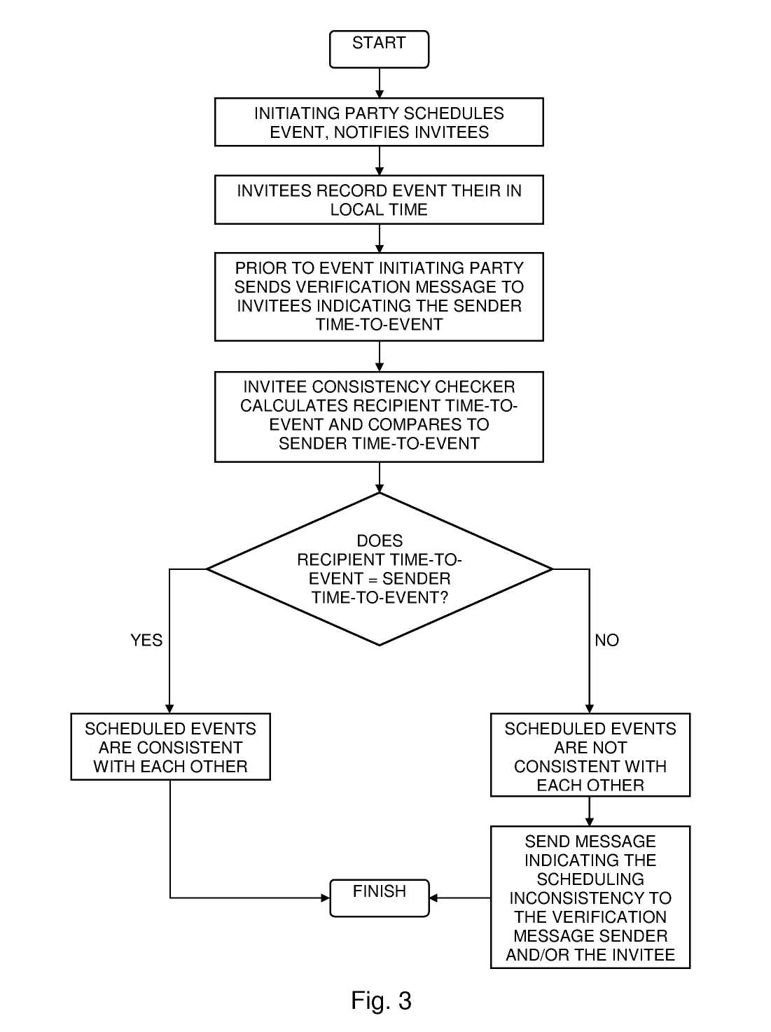

Additional reference is now made to FIG. 3, which is a simplified flowchart illustration of an exemplary method of operation of the calendar verification system of FIG. 2, operative in accordance with an embodiment of the present invention. In the method of FIG. 3, an event, such as a telephone conference, is scheduled by a party and is recorded by one or more invitees as described hereinabove with reference to FIGS. 1A and 1B. Prior to the event, such as at a predetermined time of, for example, 24 hours before the event, a verification message is sent by the initiating party to any, and preferably all, of the invitees, whose computers are configured as described in FIG. 2. The verification message preferably identifies the event, indicates the time the verification message was created, and indicates the time left from the time the verification message was created and until the event is scheduled to begin as recorded by the sender's calendar application 202, hereinafter referred to as the “sender time-to-event”. The time the verification message was created may be expressed according to the verification message sender's local time zone and/or according to another time zone or reference, such as coordinated universal time (UTC). Once the verification message is received at the invitee's computer 200, consistency checker 206 calculates the time that is left from the current time, such as according to the invitee's computer's internal clock, and until the event is scheduled to begin according to the event information that is stored on the invitee's database 204, to arrive at a “recipient time-to-event”. If the sender time-to-event is equal to the recipient time-to-event, or approximately equal within a predefined tolerance, such as to allow for the delay between when the verification message is sent and when it is received by the invitee, then the scheduled events are determined to be consistent with each other, and a message to that effect may be sent by the invitee to the verification message sender. However, if the sender time-to-event is not equal to the recipient time-to-event, or not approximately equal even within a predefined tolerance, then the scheduled events are determined not to be consistent with each other, whereupon a message indicating the scheduling inconsistency may be sent to the verification message sender and/or the invitee, such as to prompt correction of the scheduling inconsistency.

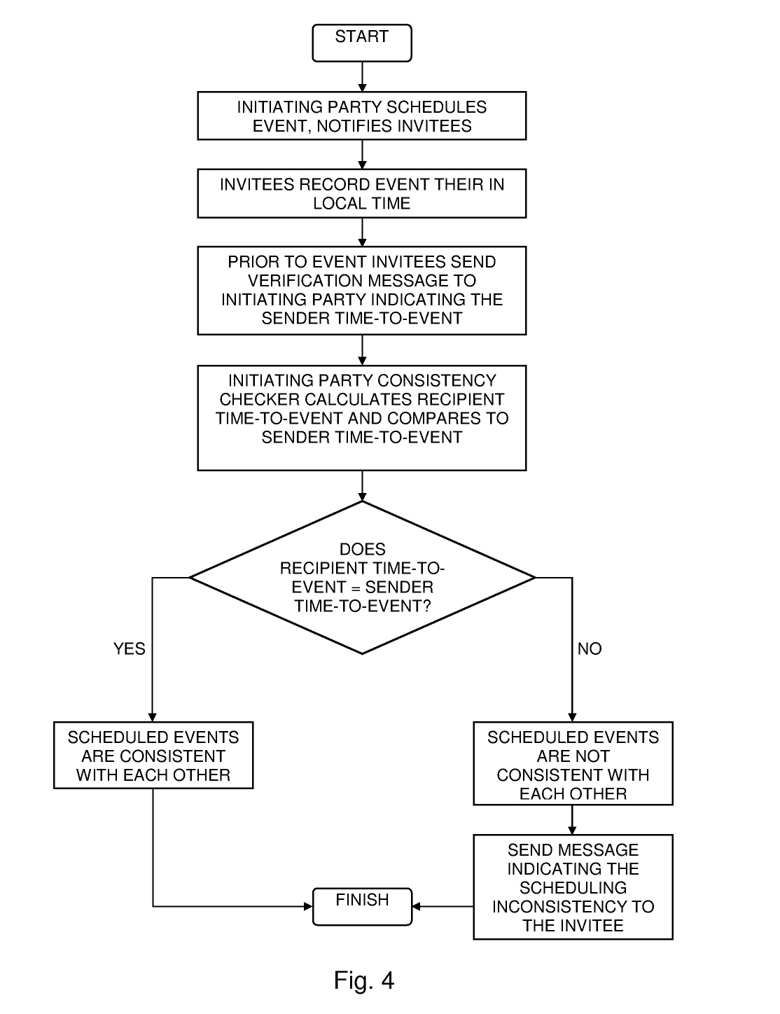

Reference is now made to FIG. 4, which is a simplified flowchart illustration of an alternate exemplary method of operation of the calendar verification system of FIG. 2, operative in accordance with an embodiment of the present invention. In the method of FIG. 4, an event, such as a telephone conference, is scheduled by a party and is recorded by one or more invitees as described hereinabove with reference to FIGS. 1A and 1B. Prior to the event, such as at a predetermined time of, for example, 24 hours before the event, a verification message is sent by any, and preferably all, of the invitees, to the party who originally scheduled the event, whose computer is configured as described in FIG. 2. The verification message preferably identifies the event, indicates the time the verification message was created, and indicates the time left from the time the verification message was created and until the event is scheduled to begin as recorded by the sender's calendar application 202, hereinafter referred to as the “sender time-to-event”. The time the verification message was created may be expressed according to the verification message sender's local time zone and/or according to another time zone or reference, such as coordinated universal time (UTC). Once the verification message is received at the original scheduling party's computer 200, consistency checker 206 calculates the time that is left from the current time, such as according to the original scheduling party's computer's internal clock, and until the event is scheduled to begin according to the event information that is stored on the original scheduling party's database 204, to arrive at a “recipient time-to-event”. If the recipient time-to-event is equal to the sender time-to-event, or approximately equal within a predefined tolerance, such as to allow for the delay between when the verification message is sent and when it is received by the original scheduling party, then the scheduled events are determined to be consistent with each other, and a message to that effect may be sent by the original scheduling party to the verification message sender. However, if the recipient time-to-event is not equal to the sender time-to-event, or not approximately equal even within a predefined tolerance, then the scheduled events are determined not to be consistent with each other, whereupon a message indicating the scheduling inconsistency may be sent to the invitee, such as to prompt correction of the scheduling inconsistency.

It is appreciated that one or more of the steps of any of the methods described herein may be omitted or carried out in a different order than that shown, without departing form the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. A computer-implemented calendar verification system comprising:
a computer configured to operate a calendar application; and
a consistency checker operable by said computer,
wherein said calendar application is operative to record information regarding a scheduled event,
and wherein said consistency checker is operative to determine the consistency of a sender time-to-event, received in a verification message for said event, with a recipient time-to-event calculated by said consistency checker using said scheduled event information.

2. The system according to claim 1 wherein said sender time-to-event indicates the time left from the time said verification message was created and until said event is scheduled to begin as recorded by a calendar application of the sender of said verification message.

3. The system according to claim 1 wherein said consistency checker is operative to calculate said recipient time-to-event as the time that is left from the current time at the recipient of said verification message and until said event is scheduled to begin as recorded by a calendar application of said recipient.

4. The system according to claim 1 wherein said consistency checker is operative, if said sender time-to-event is not equal to said recipient time-to-event, to send a message to either of the sender and the recipient of said verification message indicating a scheduling inconsistency.

5. A computer-implemented calendar verification method comprising:
receiving a verification message for a scheduled event;
accessing information regarding said scheduled event; and
determining the consistency of a sender time-to-event received in said verification message with a recipient time-to-event calculated by the recipient of said verification message using said scheduled event information.

6. The method according to claim 5 wherein any of said steps are performed at a predetermined time prior to the scheduled time of said event.

7. The method according to claim 5 wherein said receiving step comprises receiving said verification message from an invitee to said scheduled event.

8. The method according to claim 5 wherein said receiving step comprises receiving said verification message from the initiating party of said scheduled event.

9. The method according to claim 5 and further comprising calculating said sender time-to-event to indicate the time left from the time said verification message was created and until said event is scheduled to begin as recorded by a calendar application of the sender of said verification message.

10. The method according to claim 5 and further comprising calculating said recipient time-to-event as the time that is left from the current time at the recipient of said verification message and until said event is scheduled to begin as recorded by a calendar application of said recipient.

11. The method according to claim 5 and further comprising, if said sender time-to-event is not equal to said recipient time-to-event, sending a message to either of the sender and the recipient of said verification message indicating a scheduling inconsistency.

12. A computer-implemented program embodied on a computer-readable medium, the computer program comprising:
a first code segment operative to receive a verification message for a scheduled event;
a second code segment operative to access information regarding said scheduled event; and
a third code segment operative to determine the consistency of a sender time-to-event received in said verification message with a recipient time-to-event calculated by the recipient of said verification message using said scheduled event information.
